(19) United States
(12) Patent Application Publication
(10) Pub. No.: US 2007/0152577 A1
(43) Pub. Date: Jul. 5, 2007

(54) Flexible display using semiconductor light-emitting device and method of manufacturing the same

(75) Inventors: Jae-hee Cho, Yongin-si (KR); Jong-min Kim, Suwon-si (KR); Cheol-soo Sone, Anyang-si (KR)

Correspondence Address: BUCHANAN, INGERSOLL & ROONEY PC, POST OFFICE BOX 1404, ALEXANDRIA, VA, 22313-1404, US

(73) Assignee: Samsung Electro-Mechanics Co., Ltd., Suwon-si (KR)

(21) Appl. No.: 11/508,911

(22) Filed: Aug. 24, 2006

(30) Foreign Application Priority Data
Jan. 5, 2006 (KR) 10-2006-0001400

(51) Int. Cl. H05B 33/00; H01J 1/62

(52) U.S. Cl. 313/511

(57) ABSTRACT

A flexible display using semiconductor light-emitting devices and a method of fabricating the same are provided. The flexible display includes: a flexible pliable substrate; a display unit with semiconductor light-emitting devices arranged in pixels on the pliable substrate and which produces an image; and first and second circuit layers driving the semiconductor light-emitting devices. The flexible display having the above-mentioned configuration provides flexibility and the semiconductor light-emitting devices offer a high emission efficiency and a long lifespan.

### CROSS-REFERENCE TO RELATED PATENT APPLICATION

This application claims the benefit of Korean Patent Application No. 10-2006-0001400, filed on Jan. 5, 2006, in the Korean Intellectual Property Office, the disclosure of which is incorporated herein in its entirety by reference.

### BACKGROUND OF THE DISCLOSURE

1. Field of the Disclosure

The present disclosure relates to a flexible display, and more particularly, to a flexible display using a semiconductor light-emitting device that can provide an excellent emission efficiency and a long life span,

2. Description of the Related Art

Flexible displays are revolutionary paper-like displays that can be folded or rolled without damage. Due to their high portability, the flexible displays are emerging as one of the promising next-generation displays. The nature of the flexible display enables incorporation of network and storage functions into the display, thus allowing a user to conveniently see information whenever and wherever it is needed.

Research into various types of displays has been conducted when seeking to produce a flexible display. One example of these displays is an organic light-emitting diode (OLED) display. To make the OLED display flexible, the material of OLED must by necessity also be flexible. That is, the OLED display uses a plastic substrate, an organic driving circuit, a polymeric light-emitting layer, and a conductive polymer electrode instead of a glass substrate, an inorganic driving circuit, a monomolecular light-emitting layer, and an inorganic electrode, respectively. However, because the OLED has a low emission efficiency and a short lifespan due to the vulnerability of the material of organic light-emitting layer to environmental factors, such as moisture, heat or current, it is difficult to commercialize a flexible display using an OLED.

### SUMMARY OF THE DISCLOSURE

The present invention may provide a stable flexible display using a semiconductor light-emitting device with a high emission efficiency and a long lifespan and method of fabricating the same.

According to an aspect of the present invention, there may be provided a flexible display including: a flexible plastic substrate; a display unit with semiconductor light-emitting devices arranged in pixels on the plastic substrate and which produce an image; and first and second circuit layers driving the semiconductor light-emitting devices.

In preferred embodiments the pliable substrate may be formed of a polyimide, polyethersulfone (PES), polyethylene terephthalate (PET), or other thermoplastic polymeric material. The display further includes a flexible capping layer that is formed of a light transmissive material on the display unit so as to transmit light emitted by the semiconductor light-emitting devices. The capping layer preferably also is formed of a polyimide, polyethersulfone (PES), polyethylene terephthalate (PET), or other thermoplastic polymeric material.

The first circuit layer may be disposed between the pliable substrate and the display unit and the second circuit layer is disposed on the display unit. The first and second circuit layers may be sequentially disposed between the plastic substrate and the display unit. The first and second circuit layers are made of metal or a conductive polymeric material. They are made of a passive matrix.

The semiconductor light-emitting device includes red, green, and blue light-emitting diodes (LEDs) and the red LED has a AlₓGa_{y}In_{1-x-y}P (0≦x≦1, 0≦y≦1, x+y≦1) active layer and the green and blue LEDs have AlₓGa_{y}In_{1-x-y}N(0≦x≦1,0≦y≦1,x+y<1) active layers. A ratio of an area of the semiconductor light-emitting devices to an area of the pliable substrate is in the range of 0.5 to 20%. The display further includes grooves in which the semiconductor light-emitting devices are seated.

According to another aspect of the present invention, there may be provided a method of fabricating a flexible display including: forming a substrate using a flexible pliable material; depositing a first circuit layer on the pliable substrate; arranging semiconductor light-emitting devices in pixels on the first circuit layer; forming a display unit by melting and attaching the semiconductor light-emitting devices to the first circuit layer; and depositing a second circuit layer on the display unit.

### BRIEF DESCRIPTION OF THE DRAWINGS

The above and other features and advantages of the present invention will be illustrated in detailed exemplary embodiments thereof with reference to the attached drawings in which:

FIG. 1 illustrates a flexible display using a semiconductor light-emitting device according to an embodiment of the present invention;

FIG. 2 illustrates layers of the flexible display of FIG. 1 arranged in stacking order;

FIG. 3 is a modified example of the flexible display of FIG. 1;

FIG. 4 illustrates an example of a light-emitting diode (LED) used for the flexible display of FIG. 1;

FIG. 5 is a diagram of a circuit in the flexible display of FIG. 1;

FIG. 6 illustrates a flexible display using a semiconductor light-emitting device according to another embodiment of the present invention;

FIG. 7 illustrates an example of a LED in the flexible display of FIG. 6;

FIG. 8 is a diagram for illustrating the step of arranging LEDs using a metal mask in a method of fabricating a flexible display according to an embodiment of the present invention;

FIG. 9 illustrates the step of arranging LEDs using an array of magnets in a method of fabricating a flexible display according to an embodiment of the present invention; and

FIG. 10 illustrates the step of arranging LEDs using a transfer technique in a method for fabricating a flexible display according to an embodiment of the present invention.

### DETAILED DESCRIPTION OF EXEMPLARY EMBODIMENTS

A flexible display using a semiconductor light-emitting device and method of fabricating the same according to preferred embodiments of the present invention will now be described in more detail with reference to the accompanying drawings.

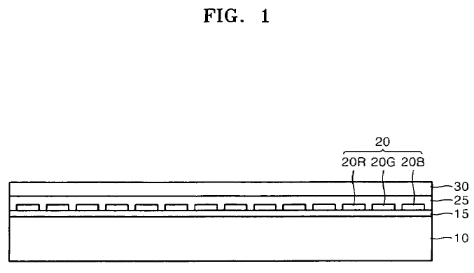

Referring to FIG. 1, a flexible display according to an embodiment of the present invention includes a flexible substrate 10 made of a flexible material and inorganic semiconductor light-emitting devices 20 arranged on the pliable substrate 10. The flexible display of the present invention has a display unit including inorganic semiconductor light-emitting devices 20.

The pliable substrate 10 is preferably formed of flexible material such as a polyimide, polyethersulfone (PES) or polyethylene terephthalate (PET) or other thermoplastic polymeric material.

The semiconductor light-emitting device 20 may be a light-emitting diode (LED) or laser diode (LD). FIG. 1 shows an embodiment of the flexible display using a LED. The LED 20 are arranged into separate pixels and contains red, green, and blue LEDs 20R, 20G, and 20B for emitting red, green, and blue light. The red, green, and blue LEDs 20R, 20G, and 20B may be arranged in a regular pattern in order to produce a color image. However, the number of LEDs 20 for each wavelength or their location may vary depending on the color temperature or the color gamut.

Specifically, a red LED includes an active layer made of AlₓGa_{y}In_{1-x-y}P (0≦x≦1,0≦y≦1,x+y≦1) and green and blue LEDs include active layers made of AlₓGa_{y}In_{1-y-x}N(0≦x≦1,0≦y≦1,x+y≦1). The structure of layers in each LED will be described in more detail later.

A first circuit layer 15 is disposed between the pliable substrate 10 and the LED 20 and provides current to the LED 20. A second circuit layer 25 is disposed on the LED 20. The first and second circuit layers 15 and 25 are constructed by forming a pattern using a photoresist and then depositing a metal layer using evaporation or plating. The metal layer may be made of Al or Au. Alternatively, the first and second circuit layers 15 and 25 may be formed of a conductive polymeric material instead of metal.

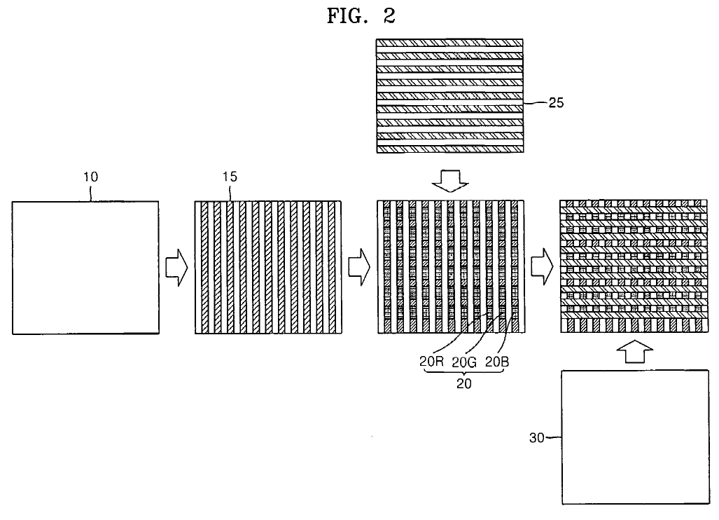

FIG. 2 illustrates layers in the flexible display that are separated according to the stacking order. A passive or active matrix may be used as the circuit layers 15 and 20. FIG. 2 illustrates that a passive matrix that preferably is low in cost and is easy to fabricate is used as the circuit layer. An active matrix offers a high response rate, making it appropriate for a motion video. When the circuit layer 15 or 25 is an active matrix circuit, each LED has a thin-film transistor (TFT) formed of A-Si, poly-Si, or organic TFT(OTFT). The locations of the first and second circuit layers 15 and 25 are determined according to the structure of an electrode, which will be described in more detail hereafter.

Referring to FIG. 2, the LEDs 20 are arranged on the first circuit layer 15 and are melted and attached to the first circuit layer 15. The second circuit layer 25 is disposed on the resulting structure. A capping layer 30 overlies the second circuit layer 25 so as to protect the underlying LEDs 20.

The capping layer 30 is formed of light-transmissive, flexible material that can transmit light emitted by the LEDs 20. For example, the capping layer 30 preferably may be formed of a polyimide, polyethersulfone (PES), polyethylene terephthalate (PET), or other thermoplastic polymeric material.

The LEDs 20 are arranged discontinuously on the pliable substrate 10 at regular intervals so as to appropriately distribute flexibility of the pliable substrate 10. In other words, the flexibility of the pliable substrate 10 and the first and second circuit layers 15 and 25 is made higher than the rigidity of the LEDs 20, thus making the entire display flexible. To achieve this, the LEDs 20 occupies approximately 0.5 to 20% of the total area of the pliable substrate 10. By adjusting the ratio of the area of the LEDs 20 to the area of the pliable substrate 10 within this range, it is possible to achieve a stable emission efficiency and a long lifespan for the display unit using the LEDs 20 as well as flexibility the entire display.

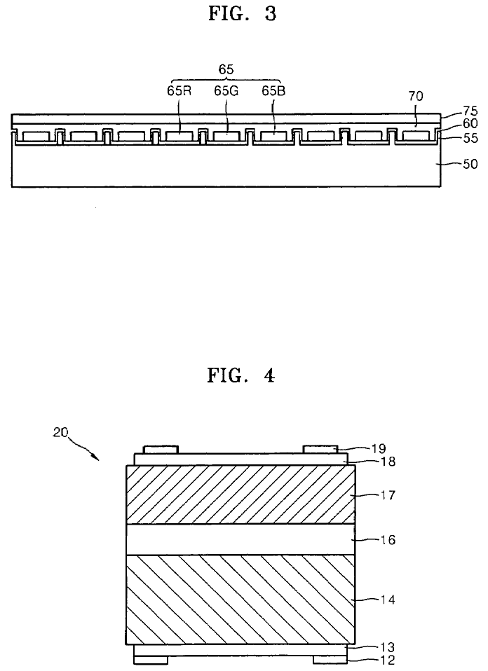

FIG. 3 is a modified example of the flexible display of FIG. 1. Referring to FIG. 3, a plurality of grooves 55 are formed in a pliable substrate 50. LEDs 65 are disposed within the plurality of grooves 55. A first circuit layer 60 is disposed on the pliable substrate 50. A second circuit layer 70 is disposed on the LEDs 65 and a light-transmissive capping layer 75 is formed over the second circuit layer 70.

The flexible display of FIG. 3 has substantially the same configuration as that shown in FIG. 1 except for the structure of the pliable substrate 50. That is, the rest of the structure, such as the first and second circuit layers 55 and 70, the LED 65, and the capping layer 75 performs substantially the same function and operation as their counterparts shown in FIG. 1.

The red, green, and blue LEDs 65R, 65G, and 65B are sequentially arranged in the grooves 55 and the ratio of the area of the LEDs 65 to the area of the pliable substrate 50 is within the range of approximately 0.5 to 20%. In this instance, the area of the pliable substrate 50 is the cross-sectional area.

First and second circuit layers may be arranged in a different fashion according to the structure of electrodes in an LED. LEDs commonly are categorized into A and B types. In an A-type LED, first and second electrodes are separately disposed on the top and bottom of the LED, respectively. In a B-type LED, the first and second electrodes are disposed on the same side thereof. The A-type LED is suitable for a structure in which first and second circuit layers are separately disposed on the top and bottom of a LED as shown in FIGS. 1 and 3.

FIG. 4 illustrates an example of an A-type LED 20. Referring to FIG. 4, the LED 20 includes an n-clad layer 14 doped with electrons, a p-clad layer 17 doped with holes, an active layer 16 in which the recombination of the electrons and holes provided by the n- and p-clad layers 14 and 17 produces photons, and the first and second transmissive contact layers 13 and 18 transmitting the photons are emitted by the active layer 16. The LED 20 further includes first and second transparent electrodes 12 and 19 on the bottom and top surfaces of the LED 20, respectively. The first electrode 12 is formed on the first transmissive contact layer 13 while the second electrode 19 is formed on portions of the second transmissive contact layer 18 through which photons exit. When positive and negative forward voltages are applied to the first and second electrodes 12 and 19, respectively, the electrons and holes generated by the n- and p-clad layers 14 and 17 move toward the active layer 16 and upon recombination of the electrons and holes, photons with bandgap energy are generated.

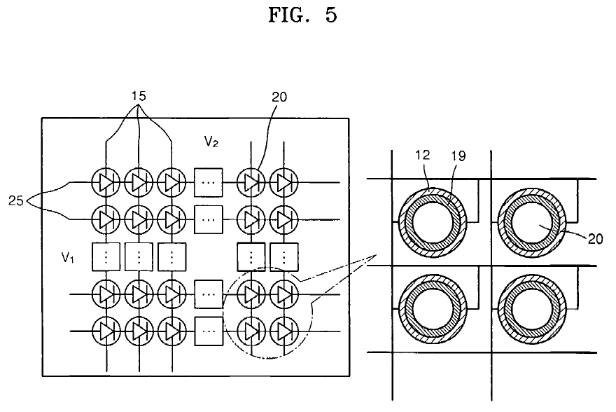

FIG. 5 is a diagram of an A-type LED mainly showing the electrode layers 12 and 19 and a passive matrix circuit. Referring to FIG. 5, the LED is driven by a difference between first voltage V₁ and second voltage V₂ applied by the first and second circuit layers 15 and 25.

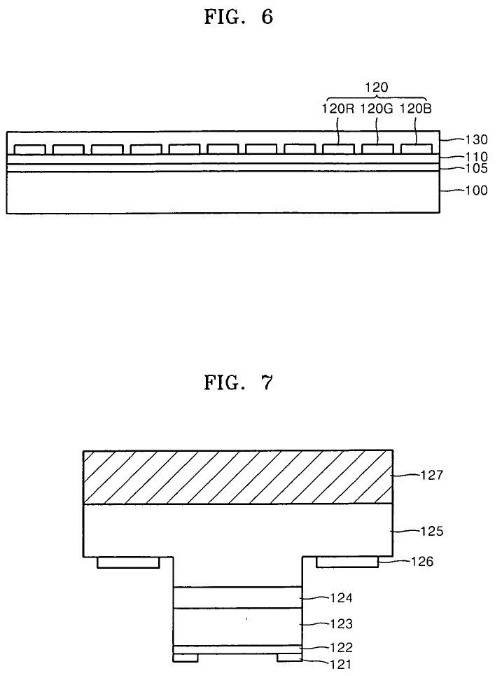

FIG. 6 illustrates the structure of layers in a flexible display using a B-type LED. Referring to FIG. 6, first and second circuit layers 105 and 110 are stacked on a pliable substrate 100. Although not shown, passivation is formed over the first and second circuit layers 105 and 110 for isolation. LEDs 120 are disposed on the second circuit layer 110 and a capping layer 120 of a light-transmissive material is formed on the LEDs 120. The LED 120 is composed of red, green, and blue LEDs 120R, 120G, and 120B in order to produce a color image.

FIG. 7 illustrates the structure of layers in a B-type LED. Referring to FIG. 7, the LED includes a sapphire substrate 127, and an n-clad layer 125, an active layer 124, a p-clad layer 123, and a transparent contact layer 122 sequentially formed on the sapphire substrate 127. First and second electrodes 126 and 121 are disposed on bottom surfaces of a stepped portion of the n-clad layer 125 and the transparent contact layer 122.

Meanwhile, a plurality of grooves (55 of FIG. 3) may be formed in the pliable substrate 100 shown in FIG. 6 and LEDs may be disposed within the plurality of grooves.

A method of fabricating a flexible display according to a preferred embodiment of the present invention will now be described with reference to FIG. 1.

A pattern corresponding to the first circuit layer 15 is formed on the pliable substrate 10 using a photoresist and then is deposited using evaporation or plating to form the first circuit layer 15. LEDs are arranged in pixels on the first circuit layer 15 to form a display unit. The LEDs may be arranged on the first circuit layer 15 using one of the exemplary techniques set forth hereafter.

First, after fabrication of the LEDs, the LEDs may be arranged on the first circuit layer 15 using pick and drop. In this instance, pick and drop for sorting after fabrication of the LEDs is performed directly on the first circuit layer 15, thus allowing the arrangement of LEDs without using a separate step.

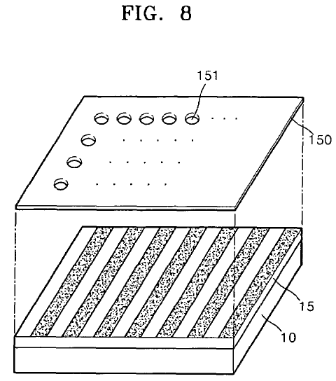

Second, LEDs may be arranged using a metal mask. As illustrated in FIG. 8, a metal mask 150 with a hole pattern 151 formed corresponding to the locations of the LEDs that will be subsequently arranged is disposed over the first circuit layer 15. Thereafter, the LEDs are dispersed over the metal mask and then are shaken so that they are mounted in place. When a plurality of color LEDs are arranged in order to produce a color image, a metal mask corresponding to each color can be used to sequentially arrange LEDs for each color.

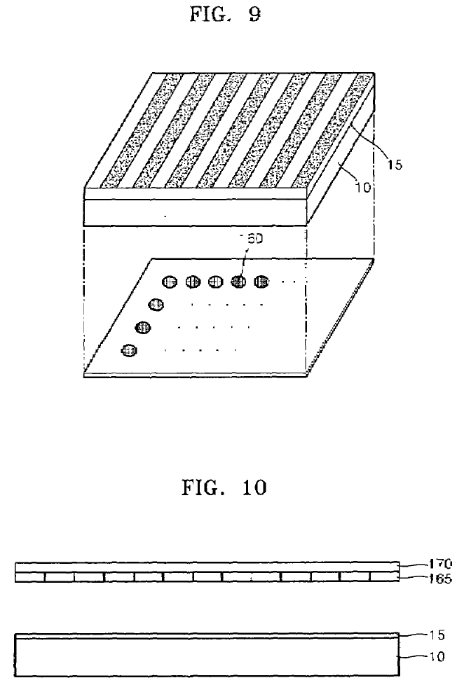

Third, LEDs may be arranged using a magnet array. Referring to FIG. 9, a magnet array 160 arranged in a pattern corresponding to the locations of LEDs to be arranged is prepared below the pliable substrate 10. After placing the magnet array 160 below the pliable substrate 10, the LEDs are dispersed over the pliable substrate 10 on which the first circuit layer 15 has been deposited and arranged according to the magnet array 160 and are mounted at proper positions. This method uses attraction between electrodes of LED and a magnet.

Fourth, LEDs may be arranged using a transfer method. Referring to FIG. 10, the transfer method involves attaching an LED wafer 165 onto a film 170 in order to reverse an image of a LED array and dicing the LED wafer 165 into chips. While the LED wafer 165 is cut into chips, the film 170 remains unchanged. The film 170 is positioned so that the LEDs oppose the first circuit layer 15. The film 170 is then expended using annealing so that the LEDs are separated from one another by a predetermined distance. After being positioned on the first circuit layer 15, the expended LEDs are annealed and are attached to the first circuit layer 15. The film 170 is then stripped off so that the LED array is transferred to the circuit first layer 15.

Fifth, LEDs may be arranged to fit the shape of a pliable substrate. That is, grooves 55 having a predetermined shape are formed in the pliable substrate and the LEDs are fabricated to have a shape corresponding to the shape of the grooves 55. For example, the grooves 55 and the LEDS may have a reversed truncated pyramidal shape. When the LEDs are dispersed over the pliable substrate on which the first circuit layer 15 has been deposited, they are mounted into the grooves 55.

When LEDs are arranged using a pick and drop and transfer method and to fit the shape of a pliable substrate, they are not reversed to an upside down arrangement. However, when the LEDs are arranged using a metal mask and magnet array, they tend to be vertically reversed. In the latter instance, the LEDs are driven using a modulation driving method, such as AC driving. When normal LEDs are modulation-driven above 50 Hz alternately with upside-down LEDs, human eyes cannot recognize the difference due to the sequential driving.

When LEDs are arranged using a metal mask, the method may apply to the A- and B-type LEDs (FIGS. 4 and 7) in a different fashion. That is, an A-type LED is modulation-driven because it can be reversed upside-down as described above. On the other hand, a B-type LED may include overlying and underlying first and second circuit layers because it may be reversed vertically. That is, the LED 120 shown in FIG. 6 may further include first and second circuit layers 105 and 110 thereon.

When LEDs are arranged using a magnet array, an A-type LED is modulation-driven because it can be turned upside-down as described above. On the other hand, a B-type LED is not reversed vertically because first and second electrodes are located on the same side.

As described above, a flexible display according to the present invention offers flexibility by arranging semiconductor light-emitting devices on a pliable substrate at predetermined intervals. The semiconductor light-emitting devices also have a high emission efficiency and a stable lifespan. The present invention also achieves flexibility for the entire display and a stable emission efficiency and a long lifespan for the semiconductor light-emitting devices by adjusting the ratio of the area of the semiconductor light-emitting devices to the area of the pliable substrate. The method for fabricating the flexible display allows the simple arrangement of the semiconductor light-emitting devices into pixels.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A flexible display comprising:
a pliable substrate;
a display unit with semiconductor light-emitting devices arranged in pixels on the pliable substrate and which produces an image; and
first and second circuit layers driving the semiconductor light-emitting devices.

2. The display of claim 1, wherein pliable substrate is a thermoplastic polymeric material.

3. The display of claim 1, wherein the pliable substrate is selected from the group consisting of a polyimide, polyethersulfone (PES), and polyethylene terephthalate (PET).

4. The display of claim 1, further comprising a flexible capping layer that is formed of a light transmissive material on the display unit so as to transmit light emitted by the semiconductor light-emitting devices.

5. A display as claimed in claim 4, wherein said capping layer is a thermoplastic polymeric material.

6. The display of claim 4, wherein the capping layer is selected from the group consisting of a polyimide, polyethersulfone (PES), and polyethylene terephthalate (PET).

7. The display of claim 1, wherein the first circuit layer is disposed between the pliable substrate and the display unit and the second circuit layer is disposed on the display unit.

8. The display of claim 1, wherein the first and second circuit layers are sequentially disposed between the pliable substrate and the display unit.

9. The display of claim 7, wherein the first and second circuit layers are constructed of metal or a conductive polymeric material.

10. The display of claim 1, wherein the first and second circuit layers are constructed of composition of a passive matrix.

11. The display of claim 1, wherein the semiconductor light-emitting device includes red, green, and blue light-emitting diodes (LEDs) and the red LED has an AlₓGa_{y}In_{1-x-y}P (0≦x≦1,0≦y≦1,x+y<1) active layer and the green and blue LEDs have AlₓGa_{y}In_{1-y-x}N(0≦x≦1,0≦y≦1,x+y≦1) active layers.

12. The display of claim 1, wherein a ratio of the area of the semiconductor light-emitting devices to the area of the pliable substrate is in the range of approximately 0.5 to 20%.

13. The display of claim 1, further comprising grooves in which the semiconductor light-emitting devices are seated.

14. A method of fabricating a flexible display, comprising:
forming a substrate of a pliable material;
depositing a first circuit layer on the pliable substrate; and
arranging semiconductor light-emitting devices in pixels on the first circuit layer;
forming a display unit by melting and attaching the semiconductor light-emitting devices to the first circuit layer; and
depositing a second circuit layer on the display unit.

15. The method of claim 14, wherein the pliable substrate is a thermoplastic polymeric material.

16. The method of claim 14, wherein the pliable substrate is selected from the group consisting of a polyimide, polylethersulfone (PES), and, polyethylene terephthalate (PET).

17. The method of claim 14, further comprising forming a flexible capping layer of a light transmissive material on the display unit so as to transmit light emitted by the semiconductor light-emitting devices.

18. The method of claim 17, wherein the capping layer is a thermoplastic polymeric material.

19. The method of claim 17, wherein the capping layer is selected from the group consisting of a polyimide, polyethersulfone (PES), and polyethylene terephthalate (PET).

20. The method of claim 14, wherein the first and second circuit layers are constructed of metal or conductive polymeric material.

21. The method of claim 14, wherein the first and second circuit layers are constructed of composition of a passive matrix.

22. The method of claim 14, wherein the semiconductor light-emitting device includes red, green, and blue light-emitting diodes (LEDs) and the red LED has an AlₓGa_{y}In_{1-x-y}P (0≦x≦1,0≦y≦1,x+y<1) active layer and the green and blue LEDs have AlₓGa_{y}In_{1-x-y}N(0≦x≦1,0≦y≦1,x+y≦1) active layers.

23. The method of claim 14, wherein the arranging of the semiconductor light-emitting devices comprises:
disposing a metal mask over the first circuit layer, the metal mask having a hole pattern corresponding to the locations of the semiconductor light-emitting devices to be arranged; and
mounting the semiconductor light-emitting devices through the metal mask.

24. The method of claim 14, wherein the arranging of the semiconductor light-emitting devices comprises:
preparing a magnet array which is arranged in a pattern corresponding to the locations of the semiconductor light-emitting devices to be arranged below the pliable substrate; and
dispersing the semiconductor light-emitting devices over the pliable substrate on which the first circuit layer has been formed, and mounting the semiconductor light-emitting devices according to the magnet array.

25. The method of claim 14, wherein the arranging of the semiconductor light-emitting devices is performed using a transfer method.

26. The method of claim 23, wherein the arranging of the semiconductor light-emitting devices is performed using a pick and drop technique.

27. The method of claim 14, further comprising forming grooves for mounting the semiconductor light-emitting devices in the pliable substrate.
